(19) United States
(12) Patent Application Publication
(10) Pub. No.: US 2013/0329251 A1
(43) Pub. Date: Dec. 12, 2013

(54) FILE PROCESSING APPARATUS, FILE PROCESSING METHOD, AND STORAGE MEDIUM

(71) Applicant: Canon Kabushiki Kaisha, Tokyo (JP)

(72) Inventor: Masao Maeda, Kawasaki-shi (JP)

(73) Assignee: Canon Kabushiki Kaisha, Tokyo (JP)

(21) Appl. No.: 13/903,826

(22) Filed: May 28, 2013

(30) Foreign Application Priority Data
May 30, 2012 (JP) 2012-123492

(51) Int. Cl. G06K 15/00

(52) U.S. Cl. CPC G06K 15/002
USPC 358/1.15

(57) ABSTRACT

A method for processing a file includes sequentially processing data included in a plurality of candidate files that can be processed by automatically switching a file to be processed according to a first order, determining, in a case where the data is processed and a switching instruction by a user is input, an order corresponding to the switching instruction from both the first order and a second order, and a switching direction, corresponding to the switching instruction, from a forward direction and a backward direction, and processing data included in a new file from among the plurality of candidate files by switching from the processed file to the new file according to the determined order and switching direction.

### BACKGROUND

1. Field

Aspects of the present invention generally relate to a file processing apparatus and a file processing method for causing a processing device to process data included in a file, and a storage medium.

2. Description of the Related Art

A function which is called slideshow display function for automatically switching images as display targets has been provided as a method for displaying a plurality of stored images on a display device. The slideshow display function enables a user to sequentially view the plurality of images without performing an operation for switching the images of the display targets. Japanese Patent Application Laid-Open No. 2006-109062 discusses a technique for selecting an image being displayed on a display screen as an image to be printed by issuing a selection instruction from a user during the slideshow display.

When a user executes the above-mentioned slideshow display, during the slideshow display, an image in a desired captured scene may be displayed as an image to be printed, for example.

However, if the slideshow display is performed in a display order without any relation to an order that images were captured, an image group included in a specific scene may not be displayed together. For example, in a case where the slideshow display is performed according to a random display order, there is no relationship among images front and back thereof in the display order, and consequently, images in various captured scenes are randomly displayed.

As a result, even if the user inputs an instruction to select an image during the slideshow execution according to the above-mentioned conventional technique, the other images included in the captured scene of the image selected by the user may not be readily played back in some cases.

### SUMMARY

According to an aspect of the present invention, a file processing apparatus includes a first control unit configured to cause a processing device to sequentially process data included in a plurality of candidate files that can be processed by automatically switching a file to be processed according to a first order, a determining unit configured to, in a case where the data is processed and a switching instruction by a user is input, determine both of an order corresponding to the switching instruction from both the first order and a second order, and a switching direction, corresponding to the switching instruction, from a forward direction and a backward direction, a second control unit configured to cause the processing device to process data included in a new file from among the plurality of candidate files, by switching from the file processed by the first control unit to the new file according to the order and the switching direction determined by the determining unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus.

FIG. 2 is an external view of a display unit and an operation unit.

FIG. 3 is an example of a file list.

FIG. 4 is a flowchart illustrating a whole flow of processing to be performed in the image processing apparatus.

FIG. 5 is a flowchart illustrating a processing content performed in a central processing unit (CPU) in a slideshow mode.

FIG. 6 illustrates transitions of images to be displayed in the slideshow mode.

FIG. 7 illustrates a slideshow display history table.

FIG. 8 illustrates transitions of images to be displayed in an image selection mode after an end of slideshow.

FIG. 9 is a flowchart illustrating an example of the processing in the image selection mode.

### DESCRIPTION OF THE EMBODIMENTS

Various exemplary embodiments, features, and aspects of the invention will be described in detail below with reference to the drawings.

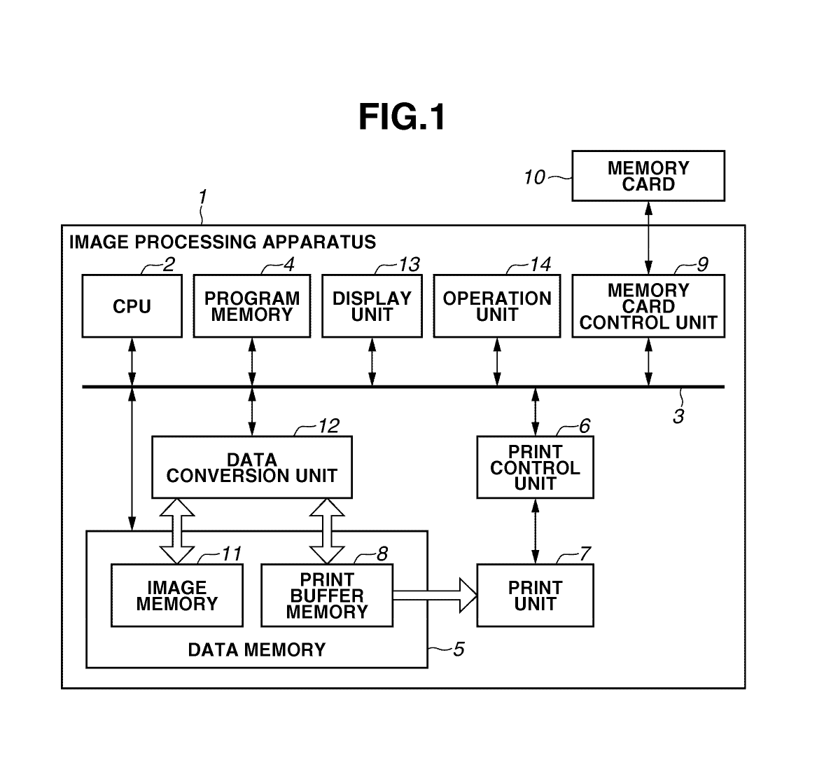

FIG. 1 is a block diagram illustrating a configuration of an image processing apparatus 1 according to an exemplary embodiment. A CPU 2 performs overall control of the image processing apparatus 1. The CPU 2 may be, for example, a microprocessor. A program memory 4 is a read-only memory (ROM) for storing a control program for various types of control performed in the image processing apparatus 1. A data memory 5 is a random access memory (RAM) for storing various types of data such as image data. The data memory 5 also serves as a work memory for the CPU 2.

The CPU 2, the program memory 4, and the data memory 5 are interconnected via an internal bus 3. The CPU 2 controls the image processing apparatus 1 by reading the control program stored in the program memory 4 to the data memory 5, and executing the control program using the data memory 5 as a work memory. In the example in FIG. 1, the image processing apparatus 1 is controlled by one processor (the CPU 2), however, the image processing apparatus 1 can be controlled by a plurality of processors cooperating with each other.

A print unit 7 is, for example, an ink-jet type printer which prints an image on a print medium by discharging ink from a recording head. A print control unit 6 controls the print unit 7 to operate, for example, a print media conveyance mechanism and a recording head. The printing method employed in the print unit 7 is not limited to the ink-jet method, alternatively, various printing methods such as an electrophotographic printing method can be employed.

A print buffer memory 8 in the data memory 5 stores print data to be printed by the print unit 7. The CPU 2 can operate the print unit 7 via the print control unit 6 and cause the print unit 7 to print an image by reading print data stored in the print buffer memory 8 and sending the data to the print unit 7.

A memory card control unit 9 controls reading and writing of data from and to a memory card 10 which is attached to the image processing apparatus 1. The CPU 2 can read data such as an image stored in the memory card 10 via the memory card control unit 9 and store the data in the data memory 5. Further, the CPU 2 can write data stored in the data memory 5 to the memory card 10.

Under the control by the CPU 2, an image stored in the memory card 10 can be stored in an image memory 11, and an image stored in the image memory 11 can be written in the memory card 10.

A data conversion unit 12 can perform conversion processing on image data, and render an image compressed by, for example a Joint Photographic Experts Group (JPEG) format into a bitmap image. In addition, the data conversion unit 12 can convert a bitmap image into print data, and store the print data in the print buffer memory 8. As described above, when image data stored in the memory card 10 is stored in the image memory 11, the image data is converted into print data by the data conversion unit 12, and the print data is stored in the print buffer memory 8. The print data is sent to the print unit 7, thus the image data stored in the memory card 10 can be printed.

The image processing apparatus 1 includes a display unit 13 such as a light-emitting diode (LED), a color liquid crystal display (LCD), or the like and an operation unit 14 such as various key switches. The CPU 2 can display, on the display unit 13, the image data stored in the image memory 11 or various guides to be indicated to users. For example, the CPU 2 performs display control to display, on the display unit 13, an image read from the memory card 10 to the image memory 11. When a user operates the operation unit 14, the CPU 2 inputs a user instruction corresponding to the operation, and performs control corresponding to the user's instruction.

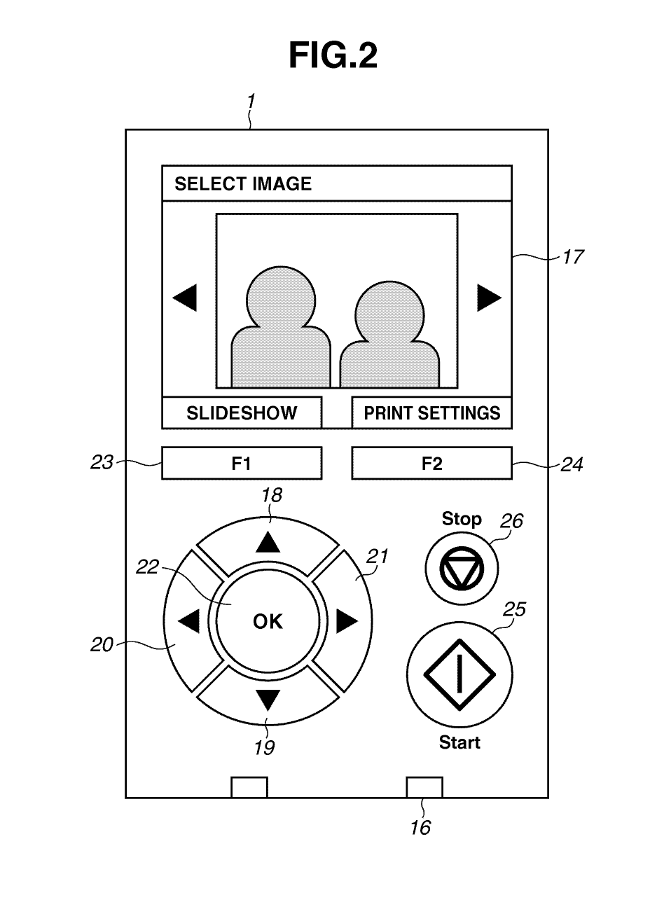

FIG. 2 is an external view of the display unit 13 and the operation unit 14 according to the present exemplary embodiment. The display unit 13 includes a state display LED 16 for displaying a state of the image processing apparatus 1, and a liquid crystal display screen 17. The operation unit 14 includes an up key 18, a down key 19, a left key 20, and a right key 21 for instructing movement in four directions. A user can switch a display target image, i.e., a display target image, by pressing these keys. The operation unit further includes an OK key 22 for instructing a selection of a function or an image, an F1 key 23 and an F2 key 24 for instructing execution of various functions, a Start key 25 for instructing a start of execution of an operation, and a Stop key 26 for instructing stop of an operation. The user can issue an instruction to execute slideshow or an instruction to stop the slideshow by pressing the Start key 25 or the Stop key 26.

According to the present exemplary embodiment, the display unit and the hard keys are separately provided as the display unit and the operation unit as illustrated in FIG. 2. Alternatively, for example, a touch panel can be provided, and a user can perform an operation by touching the touch panel on which a screen is displayed.

According to the present exemplary embodiment, in the above-described image processing apparatus 1, a plurality of images stored in the memory card 10 illustrated in FIG. 1 are displayed on the liquid crystal display screen 17 of the display unit 13 as images to be displayed, i.e., display targets. At this time, slideshow display for automatically switching the display targets can be performed. A timing for switching images in the slideshow display may be based on a time period for displaying each image which is uniformly determined, or which is differentiated for each image.

According to the present exemplary embodiment, the slideshow can be executed according to a random display order, and the display order is stored in the data memory 5. When the user presses the up key or the down key after the slideshow display is stopped, the display target image is switched according to the display order in the slideshow which is stored as described above. Meanwhile, when the user presses the right key or the left key, the display target image is switched according to a display order based on an attribute of the images such as image shooting date and time, a file name, or the like. After the image is switched, if the user presses the OK button 22, the image being displayed at that time is determined as a target to be printed on a print medium by the print unit 7.

In other words, according to the present exemplary embodiment, the image as the display target can be switched by user's operation after the slideshow display is stopped. In addition, according to the present exemplary embodiment, the display order employed in the slideshow display is stored, and the images can be switched according to the display order by a user's operation. Further, according to the present exemplary embodiment, a display order for switching display targets can be selected, by a key pressed by a user, from a display order in the slideshow display and a display order based on attributes of the images. Furthermore, a switching direction (forwarding direction and backward direction) for switching images can be determined by a key pressed by a user. In other words, the user can specify both the image advancing display order and the advancing direction by pressing the key. Thus, the user can easily display a desired image.

According to the present exemplary embodiment, as conditions for determining the display order and the switching direction, which operation the user made is determined from among a plurality of types of predetermined operations, and based on the determined type, a display order and a switching direction are determined. According to the present exemplary embodiment, types of operations are described using the types or the directions (whether up and down or right and left) of the keys pressed by the user as examples. However, types of operations are not limited to them, and various conditions such as time at which a user pressed the key and the like can be used. In a case that a touch panel is employed as the operation unit according to the present exemplary embodiment in place of the keys, for example, a direction (for example, whether up and down or right and left) of a flick operation performed by a user on the touch panel is detected to switch display orders in image switching.

Next, a slideshow display and image selection processing based on a display order in the slideshow display according to the present exemplary embodiment will be described.

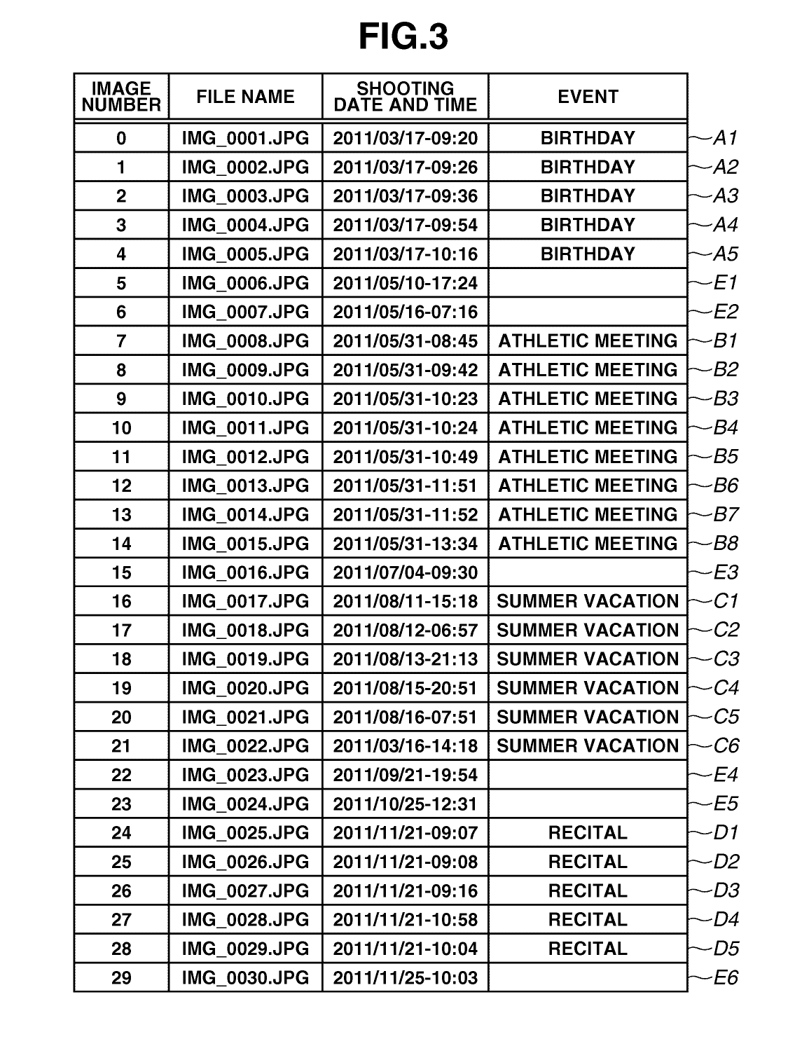

FIG. 3 is an example of a file list. According to the present exemplary embodiment, the detachable memory card 10 is attached to the image processing apparatus 1, and then, a file list of files stored in the memory card is generated. When the file list is generated, an image number is assigned to each image file, and based on the image number, a slideshow display order and a display order for switching images of the display targets by a user's operation are determined.

As illustrated in FIG. 3, the file list includes image numbers, file names, and shooting date and time. The memory card 10 is attached to the image processing apparatus 1, and the CPU 2 accesses the memory card 10 via the memory card control unit 9, and obtains file names and shooting date and time of image files in the memory card. In addition, according to the shooting date and time of each image file, an image number is assigned to each image file.

The file name can be obtained by referring to the information assigned to the file. If an image file is compliant with the Exchangeable Image File (Exif) format, the shooting date and time of the image is written in a tag in the file, and thus the CPU 2 can obtain the shooting date and time. In a case where the file does not include the shooting date and time, the CPU 2 obtains file generation date and time or file update date and time.

Alternatively, as illustrated in FIG. 3, the CPU 2 may obtain event information indicating an event (scene) corresponding to the image. In a case where the event of the image is written in the tag of the file, the CPU 2 can acquire the information. Alternatively, the CPU 2 may determine the event by analyzing the image, or determine the event based on camera settings at the shooting or the shooting date and time.

In the example in FIG. 3, it is assumed that the memory card 10 stores 30 image files. These images were mainly shot in four events, namely a birthday, an athletic meeting, a summer vacation, and a recital, and the images are stored in time series. The images A1 to A5 were shot on the birthday. The images B1 to B8 were shot at the athletic meeting. The images C1 to C6 were shot in the summer vacation. The images D1 to D5 were shot at the recital. The images E1 to E6 among the four events are classified into none of the above-described four events.

In the example illustrated in FIG. 3, the order of the images is determined based on the time information of the images. However, the order of the images is not limited to the time. The order can be determined based on various attributes of images such as the events of the images, the sizes of the images, or the types of cameras used to shoot the images. Further, other than the orders determined based on the attributes of the images, for example, an order arbitrarily specified by a user to images can be employed.

The file list also includes file path information indicating a path to a file as identification information for identifying a file. The CPU 2 can access a memory card according to the file path information to read an image file. According to the present exemplary embodiment, display control for displaying images read from a memory card on the liquid crystal screen 17 is performed. For example, in a mode for switching candidate images to be processed by a user's operation (hereinbelow, referred to as an image selection mode), the display target images are switched according to an order in the file list.

In a case where slideshow display is performed in a slideshow mode according to the present exemplary embodiment, an image number of the display target in the file list is switched every a predetermined time, and the image file corresponding to the switched image number is displayed. According to the present exemplary embodiment, from image numbers of a plurality of images included in the file list, an image number of a display target image is randomly selected, and an image file corresponding to the selected image number is displayed. Accordingly, the slideshow display is performed in the random display order.

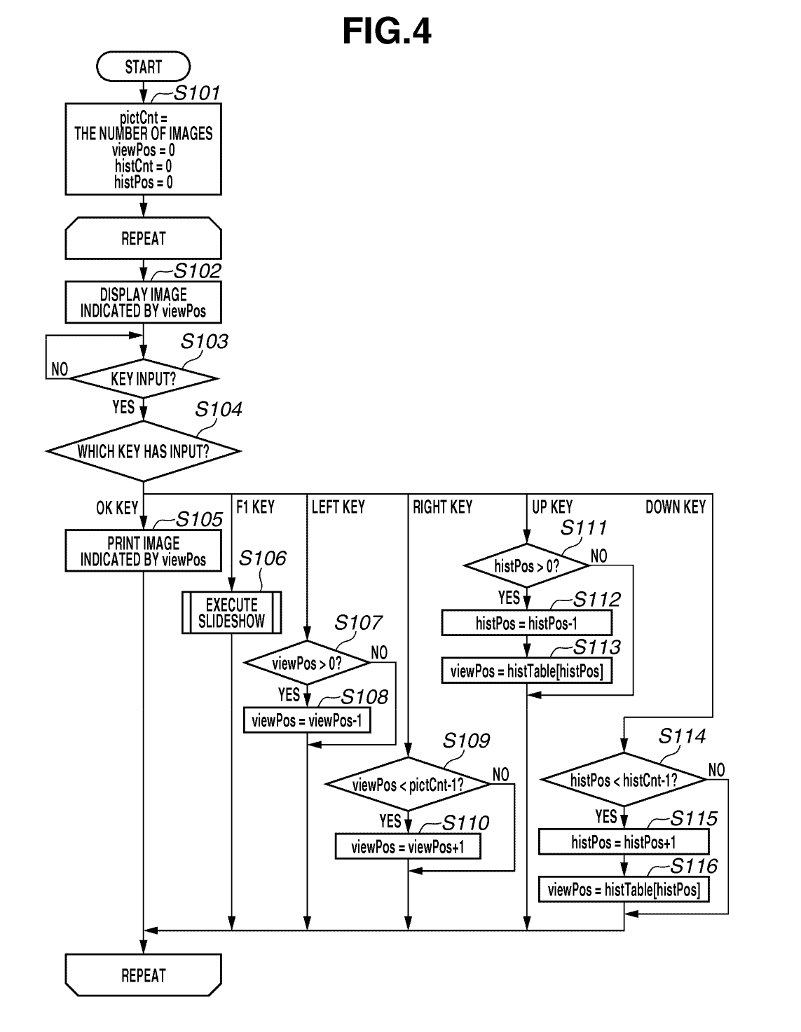

FIG. 4 is a flowchart illustrating overall processing performed in the image processing apparatus 1. A control program corresponding to the processing is described in the program memory 4, and the CPU 2 executes the control program in the data memory 5 to execute the processing according to the flowchart in FIG. 4.

The flowchart illustrated in FIG. 4 is started, for example, when a user specifies a function for displaying images with use of the operation unit 14. According to the present exemplary embodiment, at the start of the processing in the flowchart in FIG. 4, the above-described image selection mode is set, and when a user presses the right key or the left key in the operation unit 14, a display target image is switched. In the image selection mode, if the user designates slideshow, the mode is shifted to the slideshow mode.

In the processing illustrated in FIG. 4, each time an image is displayed in the slideshow display, identification information (file path information) for identifying a plurality of images displayed in the slideshow and the display order of each of the plurality of images are stored as a history. If the mode is shifted to the image selection mode after execution of the slideshow, the display target images in the slideshow display are displayed in the display order in the slideshow display based on the above-described history, according to a user's instruction. The processing is described in detail below.

In step S101, the CPU 2 initializes variables to be used in the processing in the flowchart. The variables are stored in the data memory 5. A variable pictCnt indicates a total number of image files stored in the memory card 10. According to the present exemplary embodiment, in a case where the memory card 10 including the contents illustrated in FIG. 3 is attached, the variable pictCnt is 30.

A variable viewPos indicates an image number of a display target image on the liquid crystal display screen 17. According to the present exemplary embodiment, in the image selection mode, the variable viewPos is initialized by zero to display a top image in the image files stored in the memory card 10.

A variable histCnt and a variable histPos are variables relating to slideshow. The variable histCnt indicates the number of images that have been display targets in the slideshow. The variable histPos indicates a display order in the slideshow. According to the present exemplary embodiment, at the start of the image selection mode, the slideshow has not executed, and thus the variable histCnt and the variable histPos are initialized by zero.

In step S101, the initialization of the variables is performed, and then, the CPU 2 enters a loop to repeat processing in steps S102 to S116. In step S102, the CPU 2 specifies an image file corresponding to an image number indicated by the variable viewPos in the file list in FIG. 3, reads the image file according to the file path information thereof from the memory card 10, and displays the image file on the liquid crystal display screen 17. In a case where the image file is compliant with the Exif format, the CPU 2 may display a thumbnail image stored in a header of the image file. In the initial state, in step S102, an image of the image number zero is displayed as a result of the initialization processing in step S101.

In step S103, the CPU 2 determines which key in the operation unit 14 the user has pressed. If the CPU 2 detects a key pressing operation by the user (YES in step S103), the processing proceeds to step S104. In step S104, the CPU determines the type of the key pressed by the user, and the process branches to a process corresponding to the pressed key.

In step S104, if the CPU 2 determines that the key pressed by the user is the OK key 22, the processing proceeds to step S105. In step S105, the CPU 2 outputs, to the print unit 7, the image included in the image file of the image number indicated by the variable viewPos, and causes the print unit 7 to print the image. In other words, the user can perform printing of the image of the current display target by pressing the OK key 22.

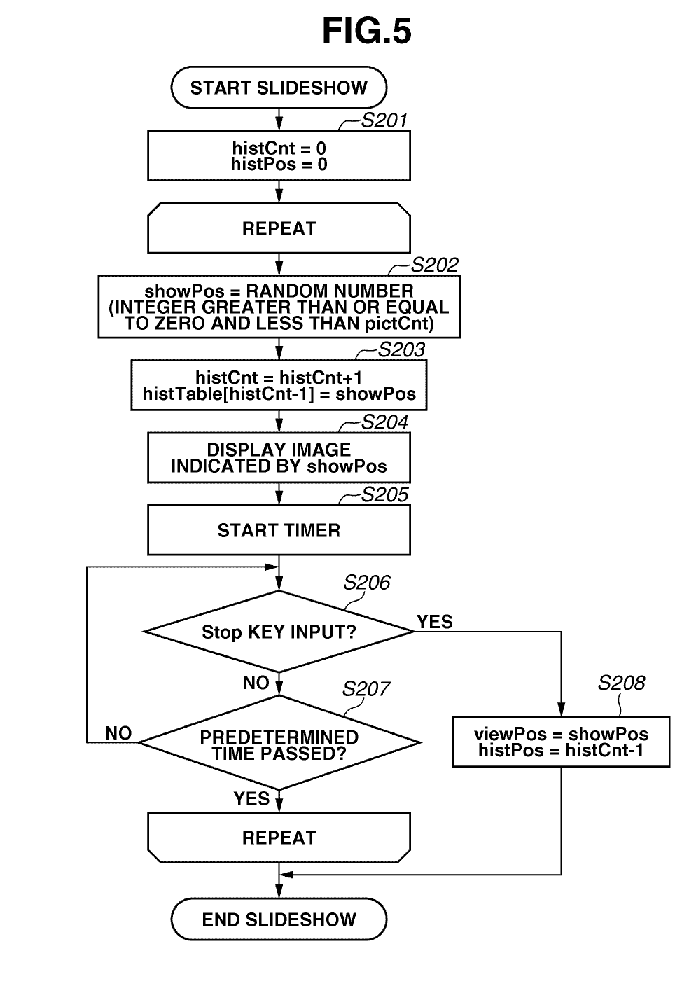

In step S104, if the CPU 2 determines that the key pressed by the user is the F1 key 23, the processing proceeds to step S106. In step S106, the slideshow operation is performed. With reference to FIG. 5, the processing contents in the slideshow operation are described.

FIG. 5 is a flowchart illustrating the processing contents performed by the CPU 2 in the slideshow mode. According to the present exemplary embodiment, it is assumed that images are displayed according to a random display order in a file list.

In step S201, the CPU 2 initializes the variable histCnt (the number of images that have been display targets in the slideshow) and the variable histPos (the display order in the slideshow). This processing is performed because in a case where the slideshow has already been performed, these two variables are not set to the initial value of zero.

Then, the CPU 2 enters a loop to repeat the processing in steps S202 to S207 at each predetermined time until an instruction to stop the slideshow is input by the user. In step S202, as a display target image, the CPU 2 generates an integer greater than or equal to zero and less than the variable pictCnt (the total number of the display candidates) as a random number, and stores the number in a variable showPos. The variable showPos indicates an image number of a display target image. The CPU 2 specifies an image file of the image number as the display target by referring to the file list. Thus, by the processing in step S202, the CPU 2 can randomly select an image file of the display target from the image files included in the file list.

In step S203, the CPU 2 adds one to the variable histCnt. The variable histCnt indicates the number of images that were displayed in the slideshow. In step S203, as information for identifying the display target image in the slideshow display, the CPU 2 stores the value of the variable showPos in a display history table histTable in the data memory 5. In other words, in step S203, each time the display target image is switched, the number of images displayed in the slideshow is updated to increment by one, and the identification information for identifying an image newly specified as the display target is stored in the memory.

Then, the processing proceeds to step S204, and the CPU 2 refers to the file list to identify the image file of the image number indicated by the variable showPos, reads the image file, and displays the image file on the liquid crystal display screen 17. In this processing, similarly to the display processing in the image selection mode in step S102, if the image file includes a thumbnail image, the CPU 2 may display the thumbnail image.

In step S205, the CPU 2 starts a timer for the slideshow display. In step S206, the CPU 2 determines whether the Stop key 26 is pressed by the user to input an instruction to stop the slideshow display. If the CPU 2 does not detect a pressing of the Stop key 26 (NO in step S206), the processing proceeds to step S207. In step S207, the CPU 2 determines whether the timer started in step S205 has measured a predetermined time. If the predetermined time has not passed (NO in step S207), the processing returns to step S206, and the CPU 2 determines again whether the Stop key 26 is pressed. If the predetermined time has passed (YES in step S207), the processing returns to step S202.

As described above, the CPU 2 repeats the processing in steps S202 to S207, and thus images can be displayed in the random display order every predetermined time. The timer started in step S205 can be reset when the processing returns from step S207 to S202, or the timer can be reset in step S205 and then started.

Meanwhile, in step S206, if the CPU 2 detects a pressing of the Stop key 26, and determines that an instruction to stop the slideshow display is input (YES in step S206), the processing proceeds to step S208. After the processing in step S208 is completed, the CPU 2 ends the slideshow mode (the processing in FIG. 5 and in step S106 in FIG. 4), and returns to the image selection mode in FIG. 4. In step S102 in FIG. 4, the image of the image number corresponding to the variable viewPos is to be displayed, and according to the present exemplary embodiment, the image displayed last in the slideshow mode as the display target image is displayed. Therefore, in step S208 in FIG. 5, the CPU 2 stores the content of the variable showPos indicating the image number displayed last in the slideshow mode in the variable viewPos (display target image) as an image to be displayed first after returning to the image selection mode. The variable histPos indicating the display order is set to indicate the bottom of the slideshow display history table histTable.

When the processing illustrated in FIG. 5 is performed as described above, the images included in the file list in FIG. 3 are displayed as slideshow in the random display order by the processing in steps S202, S205, and S207. Further, by the processing in step S203, the CPU 2 stores, in the data memory 5, the identification information for identifying the display target image in the slideshow display and the display order of the image.

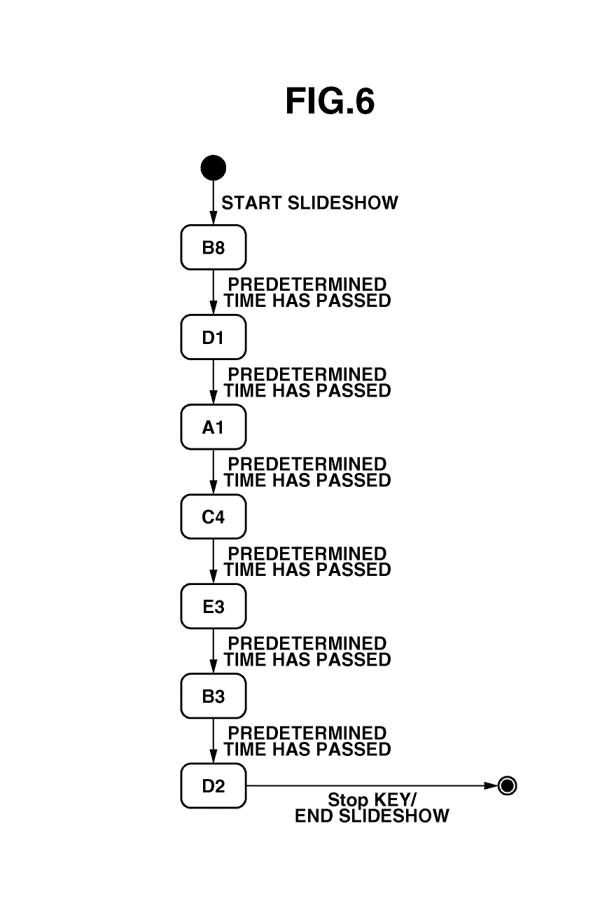

FIG. 6 illustrates transitions of display targets in the slideshow mode. FIG. 6 illustrates state transitions from the start of execution of the slideshow mode to when an image to be displayed is determined with a random number every predetermined time period and displayed. In this case, it is assumed that images (B8, D1, A1, C4, E3, B3, and D2) with the image numbers of 14, 23, 0, 19, 15, 9, and 25 in the file list in FIG. 3 are sequentially displayed by the processing in steps S202 and S204. For example, if the user presses the key to instruct stop of the slideshow by the processing in step S206 when the image D2 is being displayed, the slideshow mode is ended and the processing returns to the image selection mode.

At that time, by the processing in steps S203 and S208 in FIG. 5, a slideshow display history table indicating the image numbers (histTable [histPos]) of the images corresponding to the display order (histPos) used in the slideshow display is generated in the data memory 5.

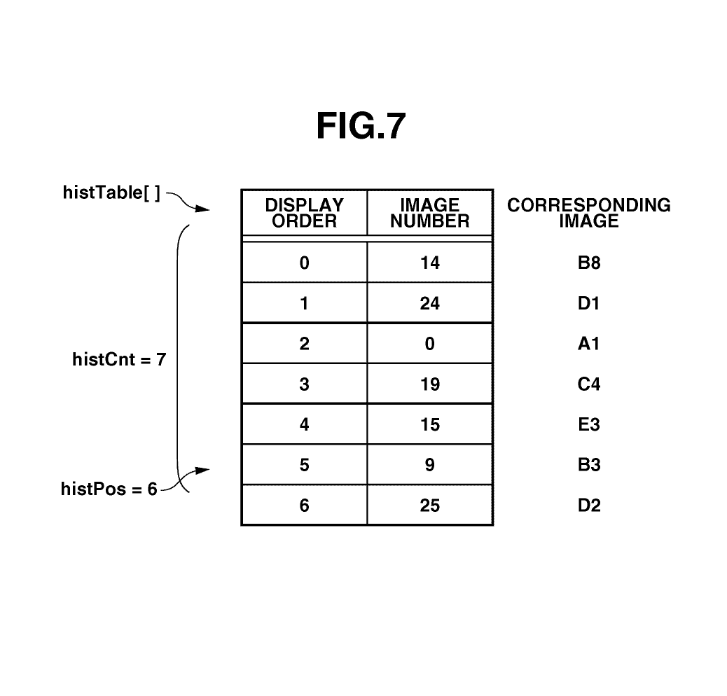

FIG. 7 illustrates an example of a slideshow display history table. The table includes the display order in the slideshow display and the image numbers of the images corresponding to the display order respectively. The CPU 2 can specify the display order in the slideshow display and the respective images displayed in the display order by referring to the table in FIG. 7.

The slideshow display processing in step S106 in FIG. 4 is described above. With reference to FIG. 4, the processing (steps S107 to S116 in FIG. 4) in the image selection mode for switching a display target image according to a user's operation is described.

According to the present exemplary embodiment, a display target image can be switched according to a display order in the slideshow display, similarly in the image selection mode. Accordingly, the display target image can be easily displayed in the slideshow display. In addition, according to an operation performed by the user via the operation unit 14, as a display order in switching the images, a display order is selected from a display order in the slideshow display and an order in the file list. The processing is described in detail below.

In step S104, if the CPU 2 determines that the key pressed by the user is the left key 20, then in steps S107 and S108, the CPU 2 performs processing to display a preceding image of the display target image in the image number order in the file list. In step S107, the CPU 2 checks whether the variable viewPos is greater than zero, that is, whether the image currently being displayed is not the top image in the file list. Only in a case where the image being displayed is not the top image (YES in step S107), the processing proceeds to step S108. In step S108, the CPU 2 subtracts one from the variable viewPos, and then the processing returns to step S102. In step S102, the CPU 2 displays, on the liquid crystal display screen 17, the image file having the image number corresponding to the variable viewPos in the file list in FIG. 3. Consequently, in this case, an image having the image number one smaller than that of the current display target image is to be displayed.

In step S104, if the CPU 2 determines that the key pressed by the user is the right key 21, then in steps S109 and S110, the CPU 2 performs processing to display an image immediately after the display target image in the image number order. In step S109, the CPU 2 checks whether the variable viewPos is less than a value (the variable pictCnt (total number of images)−1), that is, whether the image currently being displayed is the last image in the file list. Only in a case where the image being displayed is not the last image (YES in step S109), the processing proceeds to step S110. In step S110, the CPU 2 adds one to the variable viewPos, and then the processing returns to step S102. By the processing, the image having the image number one larger than that of the current display target image is to be displayed.

In step S104, if the CPU 2 determines that the key pressed by the user is the up key 18, then in steps S111 to S113, the CPU 2 displays images according to the slideshow display history order. In a case where the slideshow display is performed in step S106 as described above, the slideshow display history table illustrated in FIG. 7 is generated, and the image displayed last in the slideshow display is to be the display target image (viewPos). In steps S111 to S113, if the CPU 2 detects a pressing of the up key by the user, according to the slide show display history table, an image displayed immediately before the display target image in the slideshow display is displayed.

In step S111, the CPU 201 determines whether the variable histPos is greater than zero. If the current history number (i.e., the variable histPos) is zero, and top image in the histTable, that is, an image displayed first in the slideshow display is being displayed on the display unit 13. Thus, in the slideshow display corresponding to the display history table, no image is displayed before the current display target image. Accordingly, in the display order in the slideshow, no image exists before the current display target image, and the update processing of the display target in steps S112 and S113 is not performed. If the current history number is not zero (the top of the history table is not indicated), the CPU 2 determines that there is an image displayed prior to the image currently being displayed in the history of the slideshow display, and then, the processing proceeds to step S112.

In step S112, the CPU 2 subtracts one from the variable histPos to switch the display target image to the image immediately before in the display history table. In step S113, the CPU 2 obtains the image number of the variable histPos updated in step S112 from the display history table histTable and stores the image number in the variable viewPos to identify the image corresponding to the image number as the display target. In other words, in the slideshow display, the image displayed immediately before the image having the image number corresponding to the variable histPos is to be a new display target.

In step S104, if the CPU 2 determines that the key pressed by the user is the down key 19, then in steps S114 to S116, the CPU 2 performs processing to display an image immediately after the image being displayed in the slideshow display history order. In step S114, the CPU 2 checks whether the variable histPos is less than a value (the variable histCnt−1), that is, whether the current history number indicates a number other than the last of the display history table histTable in the slideshow executed last. If the current display target image corresponds to the last of the display history table (NO in step S114), an image immediately after the current display target does not exist in the display history. Therefore, update processing of the display target in steps S115 and S116 is not performed.

Only in a case where the current display order does not indicate the last of the history table (YES in step S114), the processing proceeds to step S115. In step S115, the CPU 2 adds one to the variable histPos. In step S116, the CPU 2 obtains the image number of the variable histPos updated in step S115 from the display history table histTable and stores the image number in the variable viewPos to identify the image corresponding to the image number as the display target. In other words, in the slideshow display in FIG. 7, the image displayed immediately after the image having the image number corresponding to the variable histPos is to be a new display target.

As described above, by repeating the processing in steps S102 to S116 in FIG. 4, the display of images can be performed in the slideshow mode in which display targets are automatically switched every predetermined time and in the image selection mode in which the display targets are switched according to a user's instruction. Especially, according to the present exemplary embodiment, when the slideshow display is performed, information for identifying a plurality of images as the display targets in the slideshow and a display order of each of the plurality of images are stored as a history. In the image selection mode, by referring to the history, images are switched in the display order in the slideshow display according to a user's instruction (up and down keys). Thus, even if a desired image is displayed in the slideshow display but a user cannot input an instruction to select the image, the image can be readily displayed in the image selection mode.

After the slideshow display is stopped by the user, according to the user's operation performed in the image switching operation, a display order in the image switching is determined. For example, according to a user's switching operation, a display order to be used in the image switching is selected from the display order in the slideshow display and the display order in the file list.

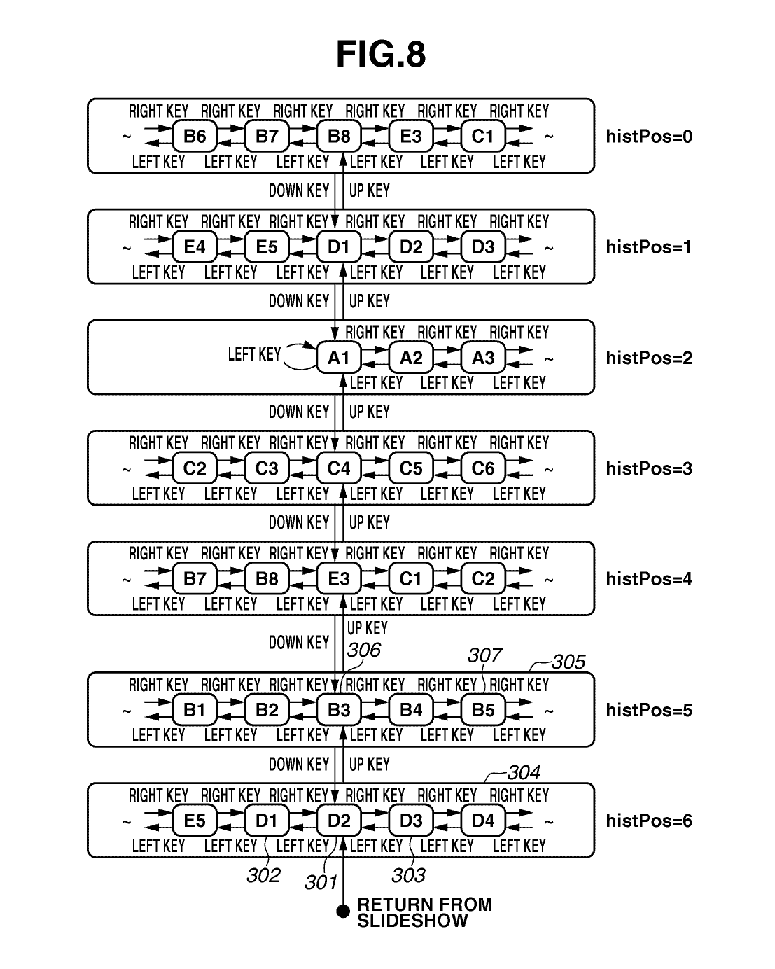

FIG. 8 illustrates transitions of display targets in the image selection mode.

It is assumed that slideshow has already been performed in the slideshow mode, and the display history table illustrated in FIG. 7 has been generated. As described in step S208 in FIG. 5, after the execution of the slideshow, the image displayed last in the slideshow display is the display target. Thus, in FIG. 8, an image having a value of six as the variable histPos in the display history table in FIG. 7 is to be the first display target. Accordingly, an image D2 corresponding to the image number 25 that is set to an array element histTable [6] in the display history table is displayed first (a state 301 in FIG. 8).

In this display state, if the user presses a key to input an instruction, transitions of the images of the display targets are performed in response to the input instruction. When the user input the left key 20 in the state 301, the state shifts to a state 302 to display an image D1. Further, when the user input the right key 21 in the state 301, the state shifts to a state 303 to display an image D3. As described above, the input of the left key 20 or the right key 21 enables the time-series display of the preceding or following images stored in the memory card 10 (the state is referred to as a state group 304).

In the state group 304, the value of the variable histPos indicating the display order is six. If the user inputs the up key 18 at any state in the state group 304, the value of the variable histPos becomes five, and the state shifts to a state group 305. At this time, an image B3 corresponding to the image number 9 set to an array element histTable [5] is displayed (a state 306). In the state group 305, the value of the variable histPos indicating the history number is five. If the user inputs the down key 19 at any state of the state group 305, the value of the variable histPos becomes six, and the state shifts to the state group 304. At this time, the image D2 corresponding to the image number 25 set to the array element histTable [6] is displayed.

As described above, the input of the up key 18 or the down key 19 in the image selection mode after the execution of the slideshow enables the display of the images displayed in the slideshow execution according to the display order in the slideshow.

Therefore, even if the user cannot input an instruction to select a desired image which is displayed in the slideshow execution, the desires image can be displayed and selected as a processing target by pressing the up key or the down key after stopping the slideshow.

Especially, according to the present exemplary embodiment, the display order is selected from the display order in the slideshow and the display order in the file list in response to the type of the operation (the type of the key or the direction) performed by the user. A display target image can be identified according to the selected display order. Thus, the user can check the image being displayed on the screen, and from the above-described two display orders, the user can select a display order suitable for displaying the desired image.

For example, it is assumed that a user sees the image B3 displayed during the execution of the slideshow illustrated in FIG. 6, recalls a specific event (the athletic meeting in the example in FIG. 3), and wants to select an image B5 captured at the event as a processing target. Then, the user performs operations as follows. The user stops the slideshow to return to the image selection mode, inputs the up key 18 from the state 301 to shift to the state 306, and further input the right key 21 twice to shift to the state 307 to display the image B5.

As described above, the user stops the slideshow in the random display order, and quickly searches the images saw during the slideshow execution and the previous and following images captured at the same event in which the relevant image was captured, so that the user can select the image as the process target.

As described above, a user can readily display an image that is a display target in slideshow display, as well as readily switch images, using the display target image as a reference, according to a display order corresponding to a predetermined order (for example, in an order of image capturing). This enables the user to readily display desired images.

Further, according to the present exemplary embodiment, as illustrated in FIG. 8, a user can press any one of the up, down, left, and right keys to specify a display order (the slideshow display order or the order of image capturing) and an image switching direction (the forwarding direction or the backward direction). For example, if an operation performed by a user is a pressing of the down key 19, the display order in the slideshow is selected and further the forwarding direction is selected as an image advancing direction in the display order. Similarly, if the up key 18 is pressed by the user, the backward direction in the display order in the slideshow is selected. If the right key or the left key is selected by the user, an image advancing direction in the forwarding direction or the backward direction is respectively selected in the display order in the file list.

In a case where event information indicating an event of an image has been obtained in addition to the file name and the shooting date and time of the image as illustrated in FIG. 3, it is possible to limit the image switching operation to be performed only in the event when a user presses the right key or the left key. In other words, when a display target image is switched in response to a pressing of the right key or the left key by the user in the state groups 304 and 305 in FIG. 8, only images in the same event as images included in a display history table may be handled as the display target.

As illustrated in FIGS. 4 and 8, according to the present exemplary embodiment, an image in the display history table is displayed in response to an up or down key pressing operation by the user regardless of whether the image as the display target is included in the display history table (whether the image was displayed in the slideshow display executed last). Thus, the user can readily and appropriately display images included in the display history table.

Further, according to the present exemplary embodiment, when the slideshow display is performed, the display order and the information for identifying the images are stored as a history. Thus, when the user stops the slideshow display, the user can identify the image which was the display target in the slideshow display. Accordingly, when the user presses the up key or the down key, switching of the images can be performed by limiting to the images actually displayed in the slideshow display. Thus, the user can readily select a desired image from the images displayed in the slideshow display.

However, the present exemplary embodiment is not limited to the method for storing the history of the slideshow display as described above, and for example, may determine a display order for each of a plurality of images to be display targets in advance before display processing, and use the display order as a history. Then, if a user performs slideshow display according to the display order, the display order and the display target images in the slideshow can be identified without newly storing the history information in displaying the images. Further, after the slideshow display is stopped, the user refers to the predetermined display order again in the image selection mode and can switch the images in the same display order as in the slideshow display.

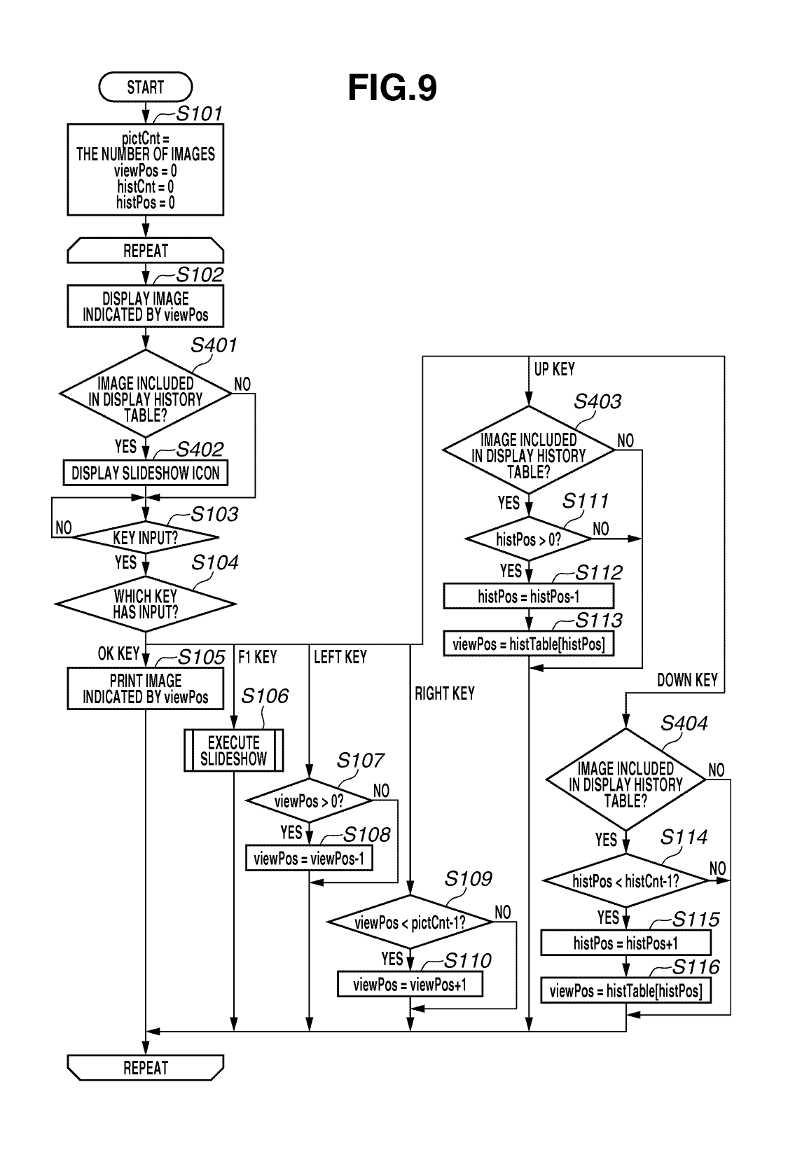

In the examples illustrated in FIGS. 4 and 8, an image that is a display target image in the image selection mode but have not been displayed in the slideshow display can be displayed when the up key or the down key is pressed in the slideshow display. However, the present exemplary embodiment is not limited to this configuration. Only in a case where a current display target image is included in a display history table, an input via the up key or the down key by a user can be received to display images according to the display history table. In other words, in a case where the image currently being displayed has not been displayed in the previous slideshow display, the image switching in the display order corresponding to the slideshow history may be limited. The processing is described with reference to FIG. 9.

FIG. 9 is a flowchart illustrating an example of the processing in the image selection mode. Descriptions of processing similar to that in the flowchart in FIG. 4 are omitted.

In step S401 in FIG. 9, the CPU 2 determines whether a display target image is included in a display history table. More specifically, the CPU 2 determines whether the image number of the variable viewPos is included in the display history table. As a result of the determination, if the display target image is included in the display history table (YES in step S401), the image displayed in step S102 has been displayed in the slideshow display. Then, in step S402, a slideshow icon is displayed. Accordingly, the user can recognize that the current display target image displayed in step S102 is the image that was displayed in the slideshow display.

In step S104, if the CPU 2 determines that the up key is pressed, then in step S403, the CPU 2 determines whether the display target image is included in the display history table. The determination processing in step S403 may be performed again similarly to that in step S401, or the determination result in step S401 is stored in the data memory 5, and the determination result may be checked. If the display target image is included in the display history table (YES in step S403), the processing proceeds to step S111 and shifts to the processing for displaying the image immediately before in the display history table.

In step S104, if the CPU 2 determines that the down key is pressed, then in step S404, the CPU 2 determines whether the display target image is included in the display history table. The determination processing is similar to that in step S403. If the display target image is included in the display history table (YES in step S404), the processing proceeds to step S114 and shifts to the processing for displaying the image immediately after in the display history table.

According to the processing illustrated in FIG. 9, if a display target image in the image selection mode has been displayed in the slideshow, the image switching can be performed according to the display order in the slideshow. Meanwhile, if the display target image has not been displayed in the slideshow, the image switching according to the display order in the slideshow is not performed. Consequently, the user can check the images that were displayed in the slideshow, and display images displayed before and after the image in the slideshow.

Further, the user is notified with the icon that the display target image has been included in the history of the slideshow display. Thus, the user can recognize that image switching can be performed in the display order in the slideshow. The display method for indicating that the display target image is included in the history of the slideshow is not limited to the icon, for example, a message to the user can be displayed. Alternatively, a display indicating that an input by the up key or the down key is enabled can be performed. Further, in a case where the current display target image is not included in the slideshow display history, an icon indicating the fact can be displayed. Accordingly, the user can recognize that the image switching according to the display order in the slideshow is limited.

As described above, according to the exemplary embodiment, a plurality of images that have been display targets in the slideshow display are sequentially displayed according to the display order of each of the plurality of images in the slideshow display according to a user's instruction. Therefore, the user can readily display the images that were displayed in the slideshow display.

According to the present exemplary embodiment, the images can be displayed based on the two types of display orders, namely the display order in the slideshow and the display order in the file list according to a type or a direction of a user's instruction (whether up and down key or right and left key) in the image selection mode. Thus, the user can check an image displayed on the screen to input an instruction to select a display order corresponding to the instruction from the two display orders.

Further, according to the present exemplary embodiment, in a display order corresponding to a type or a direction of a user's instruction, an image advancing operation is executed in a direction corresponding to the type or the direction of the user's instruction. In other words, according to the present exemplary embodiment, both an image advancing display order and a direction in the display order are determined according to which of a plurality of types of predetermined operations (pressing of the up, down, right, or left key) the user's instruction has been made. As a result, the user can specify both the specification for changing the display order and the specification of the image advancing direction by one operation without instructing these specifications by different operations respectively. Thus, the user can readily specify the display order and the image switching direction.

According to the above-described exemplary embodiment, a slideshow display order is randomly generated. However, a display order may correspond to various attributes of images. Alternatively, image display may be performed based on a display order specified by a user in advance.

Further, according to the above-described exemplary embodiment, when the user presses the OK key 22 while an image is being displayed, at the processing in step S105 in FIG. 4, the image displayed at the time of the pressing of the OK key 22 is to be printed. However, instead of immediately printing the image, information of the image may be stored in the data memory 5 as a print target candidate. If a user inputs an instruction to start printing when a plurality of images is stored as the print target candidates, the print control unit 6 may collectively output the plurality of images stored in such a way to the print unit 7 to print.

According to the above-described exemplary embodiment, when the user shifts the slideshow mode to the image selection mode, the user issues a stop instruction for stopping the slideshow in the slideshow mode. However, the above-described exemplary embodiment is not limited to the arrangement that the user inputs the stop instruction. For example, when the user presses one of the up, down, right, and left keys during the execution of the slideshow, the slideshow can be stopped and image switching corresponding to the pressed key can be performed. Then, according to the display order corresponding to the key pressed by the user, images are switched in the direction corresponding to the key. As described above, the user presses one of the up, down, right, and left keys during the slideshow execution to stop the slideshow to specify the display order for image switching and the switching direction, and further to instruct image switching.

Further, the processing performed to an image selected by a user is not limited to the print processing. For example, processing to be performed may include processing for transferring an image to a memory in the image processing apparatus 1, or processing for transmitting an image to an external device of the image processing apparatus 1 via a network. The types of data to be a display target on the display unit 13 are not limited to image data, and alternatively, various types of data pieces such as document data and graphic data can be display targets.

According to the above-described exemplary embodiment, the image processing apparatus 1 includes the display unit 13 for displaying images, the print unit 7 for printing images, and the operation unit 14 operated by a user. However, the configuration is not limited to such example. More specifically, to the image processing apparatus 1, an external display device, an external print device, and an external operation device can be connected, and via the operation device, an instruction from a user can be input to cause the display device and the print device to display and print an image, respectively.

According to the above-described exemplary embodiment, when a user presses one of the up, down, right, and left keys, switching of images is performed according to a display order and a switching direction corresponding to the pressed key. In the processing, switching according to the image capturing order can be performed by a pressing of the up key or the down key, and switching according to the slideshow display order can be performed by a pressing of the right key or the left key. Further, the types of the keys are not limited to the up, down, right, and left keys. For example, both a display order and an image switching method may be associated with each of a plurality of keys arranged in a predetermined order, and according to an order in the arrangement order of the keys pressed by a user, a display order and a switching direction may be determined.

A display for prompting a user to switch images by pressing a key, or a display for notifying the user of a display order and an image switching direction corresponding to each key can be provided when slideshow display is executed or slideshow display is stopped.

According to the above-described exemplary embodiment, an example that the user presses a key to issue an instruction to switch a display target image is described. However, the instruction method is not limited to this example, and for example, a switching instruction may be issued by a user touching a touch panel. In such a case, the display image switching operation may be performed according to a different display order, for example, depending on a case where the user has performed a flick operation in the up and down direction or in the right and left direction on the touch panel. Alternatively, a display order to be used in image switching may be differentiated according to various conditions such as a time period or an area a user touches on the touch panel at the time of a switching operation.

Further, according to the above-described exemplary embodiment, as the display orders that can be specified by a user, the two display orders, i.e., the slideshow display order and another display order (an order of image capturing) are described. However, the display orders are not limited to the above, and a plurality of display orders other than the slideshow display order may be provided. For example, six or more keys that can be used for image switching can be provided, and each of the six or more keys may be associated with the forwarding direction or the backward direction in the slideshow display order, and the forwarding direction or the backward direction in the plurality of display orders. Similarly, in a case where image switching is performed by a flick operation on the touch panel, the flick directions made by the user can be classified into six or more directions to provide a plurality of display orders other than the slideshow display order.

According to the above-described exemplary embodiment, it is described that the display device reproduces an image file to display the images on the display screen as an example of the file reproduction control processing. However, the reproduction processing is not limited to this example. The reproduction processing may be processing to output sound by an output device based on a sound file including music and sound data such as voice. In such a case, for example, if a user issues an instruction to switch a tune when the tune is played back by a music file reproduction, the tune is switched according to a reproduction order and a switching direction according to the switching instruction. For example, when tunes are sequentially played back in a random reproduction order and if the user performs a flick operation in the up or down direction on the touch panel, the tune as a reproduction target is switched in the forwarding direction or the backward direction in the random reproduction order. If the user performs a flick operation in the right or left direction, the reproduction target tune is switched according to a predetermined order, for example, an order of tunes in an album or an order of artists of the tunes.

According to the above-described exemplary embodiment, display of an image included in an image file and output of sound included in a sound file are described as examples of the processing to be performed on a file. However, the processing is not limited to these examples. The above-described exemplary embodiment can be applied to, for example, a case where a file is transferred to an external device, and a case where a file is stored in a memory.

Additional embodiments can also be realized by a computer of a system or apparatus that reads out and executes computer executable instructions recorded on a storage medium (e.g., computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Hardware such as a circuit for executing a part of a program for implementing the present exemplary embodiment can be provided, and the processing described according to the present exemplary embodiment can be implemented with the hardware and a computer for executing the program cooperating with each other.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2012-123492 filed May 30, 2012, which is hereby incorporated by reference herein in its entirety.

What is claimed is:

1. A file processing apparatus comprising:
a first control unit configured to cause a processing device to sequentially process data included in a plurality of candidate files that can be processed by automatically switching a file to be processed according to a first order;
a determining unit configured to, in a case where the data is processed by the first control unit and a switching instruction by a user is input, determine an order corresponding to the switching instruction from the first order and a second order, and a switching direction, corresponding to the switching instruction, from a forward direction and a backward direction; and
a second control unit configured to cause the processing device to process data included in a new file from among the plurality of candidate files by switching from the file processed by the first control unit to the new file according to the order and the switching direction determined by the determining unit.

2. The file processing apparatus according to claim 1, wherein the determining unit determines the switching instruction by the user from a plurality of predetermined switching instructions respectively corresponding to one of the first order and the second order and one of the forward direction and the backward direction, and determines an order and a switching direction corresponding to the determined switching instruction.

3. The file processing apparatus according to claim 1, further comprising:
an obtaining unit configured to obtain information indicating a file to be a process target by the first control unit,
wherein the second control unit switches the new file to be the process target by the first control unit based on the information obtained by the obtaining unit.

4. The file processing apparatus according to claim 1, wherein the switching instruction is input by instructing a direction by a user, and the determining unit determines both the order and the switching direction based on the instructed direction.

5. The file processing apparatus according to claim 4, wherein the determining unit determines both the order and the switching direction based on which one of an up, down, right, or left direction the instructed direction corresponds to.

6. The file processing apparatus according to claim 1, further comprising:
a stop unit configured to stop the automatic switching processing by the first control unit according to an instruction by a user,
wherein the second control unit, in a case where the automatic switching processing is stopped, and the switching instruction is input, causes the processing device to process the data included in the new file according to the switching instruction.

7. The file processing apparatus according to claim 1, wherein the first control unit automatically switches a file to be processed on a predetermined time basis.

8. The file processing apparatus according to claim 1, wherein the second order is an order corresponding to respective attributes of the plurality of candidate files.

9. The file processing apparatus according to claim 1, wherein the processing performed by the first control unit and the second control unit includes processing for displaying an image by a display device based on an image file or processing for outputting a sound by an output device based on a sound file.

10. A method for processing a file, the method comprising:
sequentially processing data included in a plurality of candidate files that can be processed by automatically switching a file to be processed according to a first order;
determining, in a case where the data is processed and a switching instruction by a user is input, an order corresponding to the switching instruction from the first order and a second order, and a switching direction, corresponding to the switching instruction, from a forward direction and a backward direction; and
processing data included in a new file from among the plurality of candidate files by switching from the processed file to the new file according to the determined order and switching direction.

11. The method according to claim 10, further comprising:
determining the switching instruction by the user from a plurality of predetermined switching instructions respectively corresponding to one of the first order and the second order and one of the forward direction and the backward direction; and
performing the switching to the new file based on an order and a switching direction corresponding to the determined switching instruction.

12. The method according to claim 10, further comprising:
obtaining information indicating a file to be a target of the process by the automatically switching; and
switching to the new file to be the target of the process by the automatically switching based on the obtained information and the switching instruction.

13. The method according to claim 10, wherein the switching instruction is input by instructing a direction by a user, and both the order and the switching direction are determined based on the instructed direction.

14. The method according to claim 13, wherein both the order and the switching direction is determined based on which one of an up, down, right, or left the instructed direction corresponds.

15. The method according to claim 10, further comprising:
stopping the automatic switching according to an instruction by a user; and
processing the data included in the new file according to the switching instruction in a case where the automatic switching is stopped and the switching instruction is input.

16. The method according to claim 10, wherein a file to be processed is automatically switched on a predetermined time basis.

17. The method according to claim 10, wherein the second order is an order corresponding to respective attributes of a plurality of candidate files.

18. The method according to claim 10, wherein sequentially processing data includes processing for displaying an image by a display device based on an image file or processing for outputting a sound by an output device based on a sound file.

19. A computer-readable storage medium storing a program for causing a computer to execute a method according to claim 10.
